(19) United States
(12) Patent Application Publication
(10) Pub. No.: US 2024/0121843 A1
(43) Pub. Date: Apr. 11, 2024

(54) MULTI-LINK COMMUNICATIONS WITH MILLIMETER WAVE (MMWAVE) LINK

(71) Applicant: NXP USA, Inc., Austin, TX (US)

(72) Inventors: Liwen Chu, San Ramon, CA (US); Kiseon Ryu, San Diego, CA (US); Hongyuan Zhang, Fremont, CA (US)

(21) Appl. No.: 18/378,604

(22) Filed: Oct. 10, 2023

Related U.S. Application Data
(60) Provisional application No. 63/378,908, filed on Oct. 10, 2022.
(60) Provisional application No. 63/380,262, filed on Oct. 20, 2022.

(51) Int. Cl. H04W 76/15

(52) U.S. Cl. CPC H04W 76/15; H04W 84/12

(57) ABSTRACT

Embodiments of a method and apparatus for wireless communications are disclosed. In an embodiment, a wireless multi-link device (MILD) includes a controller configured to generate a millimeter wave (mmWave) beacon and a wireless transceiver configured to transmit the mmWave beacon to a second wireless MILD through an mmWave link between the wireless MLD and the second wireless MLD.

### CROSS-REFERENCE TO RELATED APPLICATIONS

This application is entitled to the benefit of U.S. Provisional Patent Application Ser. No. 63/378,908, filed on Oct. 10, 2022, and U.S. Provisional Patent Application Ser. No. 63/380,262, filed on Oct. 20, 2022, each of which is incorporated by reference herein.

### BACKGROUND

In multi-link communications, an access point (AP) multi-link device (MLD) can transmit various types of information using different transmission techniques to a non-AP MLD. For example, a wireless AP MLD may wirelessly transmit data to one or more wireless stations in a non-AP MLD through one or more wireless communications links, such as a millimeter wave (mmWave) link. To facilitate the proper data transmission within a multi-link communications system having an mmWave link, there is a need for multi-link communications technology that can efficiently convey communications signaling information, for example, information related to data, communications links, and/or multi-link devices (e.g., operation and/or capability parameters of multi-link devices) within the multi-link communications system.

### SUMMARY

Embodiments of a method and apparatus for wireless communications are disclosed. In an embodiment, a wireless multi-link device (MLD) includes a controller configured to generate a millimeter wave (mmWave) beacon and a wireless transceiver configured to transmit the mmWave beacon to a second wireless MLD through an mmWave link between the wireless MLD and the second wireless MLD. Other embodiments are also disclosed.

In an embodiment, the mmWave beacon includes a light mmWave beacon that does not include full mmWave link information of the mmWave link.

In an embodiment, the wireless MILD includes an access point (AP) MLD that includes a wireless AP, and the wireless AP includes the controller and the wireless transceiver.

In an embodiment, the second wireless MILD includes a non-AP MLD that includes a non-AP station (STA).

In an embodiment, the controller is further configured to generate full mmWave link information of the mmWave link.

In an embodiment, the wireless transceiver is further configured to transmit the full mmWave link information of the mmWave link to the second wireless MILD through a non-mmWave link between the wireless MLD and the second wireless MILD.

In an embodiment, the non-mmWave link includes one of a 2.4 Gigahertz (GHz) link, a 5 GHz link, or a 6 GHz link.

In an embodiment, the wireless transceiver is further configured to transmit the full mmWave link information of the mmWave link to the second wireless MILD through the mmWave link.

In an embodiment, the mmWave link includes a 45 GHz link or a 60 GHz link.

In an embodiment, the controller is further configured to generate a second mmWave beacon or a beacon extension that contains the full mmWave link information of the mmWave link.

In an embodiment, the controller is further configured to generate a multi-link probe response that contains the full mmWave link information of the mmWave link.

In an embodiment, the wireless MILD device is compatible with an Institute of Electrical and Electronics Engineers (IEEE) 802.11 protocol.

In an embodiment, the controller is further configured to generate a unicast frame that contains control or management information of the mmWave link, and the wireless transceiver is further configured to transmit the unicast frame through the mmWave link.

In an embodiment, the controller is further configured to generate a broadcast frame that contains control or management information of the mmWave link, and the wireless transceiver is further configured to transmit the broadcast frame through a non-mmWave link.

In an embodiment, a wireless access point (AP) of an access point (AP) MLD includes a controller configured to generate a millimeter wave (mmWave) beacon and a wireless transceiver configured to transmit the mmWave beacon to a non-AP MLD through an mmWave link between the AP MLD and the non-AP MLD, where the mmWave beacon includes a light mmWave beacon that does not include full mmWave link information of the mmWave link.

In an embodiment, the controller is further configured to generate full mmWave link information of the mmWave link.

In an embodiment, the mmWave link includes a 45 GHz link or a 60 GHz link.

In an embodiment, a method for wireless communications involves at a first wireless multi-link device (MILD), generating a millimeter wave (mmWave) beacon and from the first wireless MLD, transmitting the mmWave beacon to a second wireless MILD through an mmWave link between the first wireless MILD and the second wireless MLD.

In an embodiment, the mmWave beacon includes a light mmWave beacon that does not include full mmWave link information of the mmWave link.

In an embodiment, the first wireless MLD includes an access point (AP) MLD, and the second wireless MLD includes a non-AP MLD.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system in accordance with an embodiment of the invention.

FIG. 2 depicts an example format of a frame body of a light mmWave beacon frame in accordance with an embodiment of the invention.

FIG. 3 depicts an mmWave link between an AP MLD and a non-AP MLD that can be used to transmit a light mmWave beacon frame.

FIG. 4 depicts an example format of part of a full mmWave beacon frame in accordance with an embodiment of the invention.

FIG. 5 depicts an mmWave link between an AP MLD and a non-AP MLD that can be used to transmit a full mmWave beacon frame.

FIG. 6 depicts a wireless device in accordance with an embodiment of the invention.

FIG. 7 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MILD) of a wireless local area network (WLAN) may transmit data to at least one associated station (STA) MLD. The AP MLD may be configured to operate with associated STA MLDs according to a communication protocol. For example, the communication protocol may be an Institute of Electrical and Electronics Engineer (IEEE) 802.11 communication protocol.

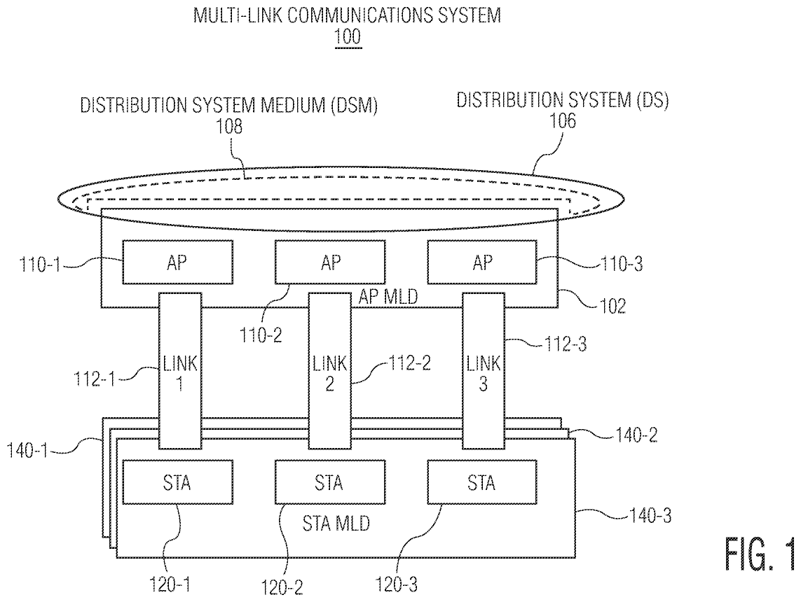

FIG. 1 depicts a multi-link (ML) communications system 100 in accordance with an embodiment of the invention. In the embodiment depicted in FIG. 1, the multi-link communications system includes at least one AP multi-link device (MLD) 102, and one or more non-AP multi-link devices, which are, for example, implemented as station (STA) MLDs 104-1, 104-2, 104-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 104-1, 104-2, 104-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, 110-3, implement lower layer MAC functionalities (e.g., backoff, frame transmission, frame reception, etc.). The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one wireless local area network (WLAN) communications protocol (e.g., at least one IEEE 802.11 protocol). For example, the APs 110-1, 110-2, 110-3 may be wireless APs compatible with at least one WLAN communications protocol (e.g., at least one IEEE 802.11 protocol).

In some embodiments, an AP MLD (e.g., the AP MLD 102) is connected to a local network (e.g., a local area network (LAN)) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 110-1, 110-2, 110-3 of the AP MLD 104 operates in different frequency bands. For example, at least one of the APs 110-1, 110-2, 110-3 of the AP MLD 104 operates in an Extremely High Frequency (EHF) band or the “millimeter wave (mmWave)” frequency band. In some embodiments, the mmWave frequency band is a frequency band between 20 Gigahertz (GHz) and 300 GHz. For example, the mmWave frequency band is a frequency band above 45 GHz, e.g., a 60 GHz frequency band. For example, the AP 110-1 may operate at 6 Gigahertz (GHz) band (e.g., in a 320 MHz (one million hertz) Basic Service Set (BSS) operating channel or other suitable BSS operating channel), the AP 110-2 may operate at 5 GHz band (e.g., a 160 MHz BSS operating channel or other suitable BSS operating channel), and the AP 110-3 may operate at 60 GHz band (e.g., a 160 MHz BSS operating channel or other suitable BSS operating channel). In the embodiment depicted in FIG. 1, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STAs) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 104-1, such that the STA MLD may be a communications device that wirelessly connects to a wireless AP MHLD, such as, the AP MLD 102. For example, the STA MLD 104-1 (e.g., at least one of the non-AP STAs 120-1, 120-2, 120-3) may be implemented in a laptop, a desktop personal computer (PC), a mobile phone, or other communications device that supports at least one WLAN communications protocol. In some embodiments, the STA MLD and its affiliated STAs 120-1, 120-2, 120-3 are compatible with at least one IEEE 802.11 protocol. In some embodiments, each of the non-AP STAs 120-1, 120-2, 120-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 108. In some embodiments, the STA MLD 104-1 implements a common MAC data service interface and the non-AP STAs 120-1, 120-2, 120-3 implement a lower layer MAC data service interface. In some embodiments, the AP MLD 102 and/or the STA MLDs 104-1, 104-2, 104-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STAs 120-1, 120-2, 120-3 of the STA MLD 104-1 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. For example, the STA 120-1 may operate at 6 GHz band (e.g., in a 320 MHz (one million hertz) BSS operating channel or other suitable BSS operating channel), the STA 120-2 may operate at 5 GHz band (e.g., a 160 MHz BSS operating channel or other suitable BSS operating channel), and the STA 120-3 may operate at 60 GHz band (e.g., a 160 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the MLD 104-1. For example, the MLD 104-2 or 104-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 1, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In the embodiment depicted in FIG. 1, the communications links 112-1, 112-2, 112-3 between the AP MLD and the STA MLD 104-1 involve at least one mmWave link. For example, the communications links 112-1, 112-2, 112-3 between the AP MLD 102 and the STA MLD 104-1 include an mmWave link (e.g., a 45/60 GHz link) between an AP of the AP MLD 102 and an STA of the STA MLD 104-1 operating in an mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 104-1 operating in non-mmWave frequency bands (e.g., 2.4 GHz, 5 GHz, or 6 GHz frequency bands). In another example, the communications links 112-1, 112-2, 112-3 between the AP MLD 102 and the STA MLD 104-1 include two mmWave links (e.g., 45/60 GHz links) between APs of the AP MLD 102 and STAs of the STA MLD 104-1 operating in mmWave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 104-1 operating in a non-mmWave frequency bands (e.g., a 2.4 GHz, 5 GHz, or 6 GHz frequency band). The control and management of an mmWave link, for example, a 45 GHz/60 GHz link may be performed in a non-mmWave link, for example, a 2.4 GHz, 5 GHz, or 6 GHz link. For example, the association of a non-AP MLD with an mmWave link can be done through a non-mmWave MHz link. However, beaconing and channel switch can be challenging for a MLD system with one or more mmWave links.

In some embodiments, a light mmWave beacon is used. The full information of an mmWave link can be announced in a non-mmWave link, for example a 2.4/5/6 GHz link. In some embodiments, the light mmWave beacon includes at least part of or all of the following information, such as, timing synchronization function (TSF) time and beacon interval, a service set identifier (SSID), the Basic Service Set (BSS) color of a BSS, the primary channel (e.g., the primary 80 MHz channel assuming the minimal channel in an mmWave link being 80 MHz), the bandwidth (BW) of the BSS operating channel, the channel puncture information, broadcast Target Wake Time (TWT) information, and/or mmWave link time domain resource structure and schedule information. In some embodiments, if the minimal channel in an mmWave link is 160 MHz, the primary channel is updated accordingly. In some embodiments, the channel puncture information is described as a bitmap. For example, each bit is related to an 80 MHz channel, and the lowest bit is the lowest 80 MHz channel of the BSS operating channel. In a first option, the AP MLD information with which an mmWave AP is affiliated is not carried in light beacon. In a second option, the AP MLD information with which the mmWave AP is affiliated is carried in light beacon. For example, reduced neighbor report (RNR) and basic multi-link element with common information is carried in light beacon. In some embodiments, the beacon being transmitted in an mmWave band link is used for channel selection of a neighbor BSS, the BSS Color collision resolution, whether the non-AP MLD can reach the AP MLD through mmWave link, etc. Operation/Capabilities information of an mmWave AP affiliated with the same AP MLD can be carried in a management/action frame (e.g., a beacon frame, a beacon extension frame) in a non-mmWave link (e.g., a 2.4/5/6 GHz link). In some embodiments, before using an mmWave channel (e.g., 60 GHz channel) as its the BSS operating channel, an mmWave AP (e.g., a 60 GHz AP) monitors the channel for a certain time duration to detect whether there is another AP that uses the channel or has the channel overlapping with the candidate channel. The AP's beacon can assist such operation.

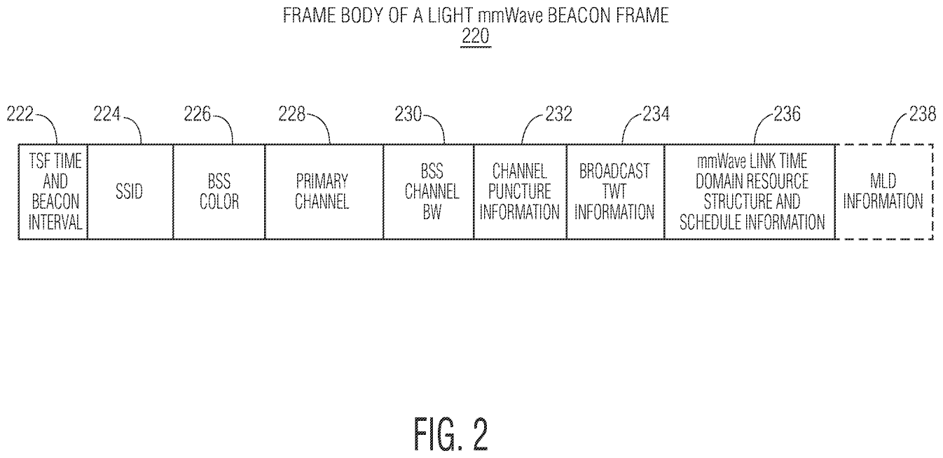

FIG. 2 depicts an example format of the frame body in a light mmWave beacon frame (the MAC header, Frame Check Sequence (FCS) of the light Beacon are not shown) 220 in accordance with an embodiment of the invention. In the embodiment depicted in FIG. 2, the frame body of the light mmWave beacon frame 220 includes a field containing TSF time and beacon interval 222, a field containing SSID 224, a field containing the BSS color 226 of a corresponding BSS (e.g., a BSS with which an mmWave AP is affiliated), a field containing the primary channel information 228, a field containing the bandwidth (BW) of the BSS operating channel 230, a field containing the channel puncture information 232, a field containing broadcast TWT information 234, a field containing mmWave link time domain resource structure and schedule information 236, and an optional field 238 containing the AP MLD information with which an mmWave AP is affiliated. Although the fields of the light mmWave beacon frame 220 are shown in FIG. 2 in certain order, other embodiments of the light mmWave beacon frame may include the same, fewer, or more fields in a different order. In addition, although the frame body of the light mmWave beacon frame 220 is shown in FIG. 2 with certain fields, other embodiments of the light mmWave beacon frame may include fewer or more fields to carry the same, less, or more information.

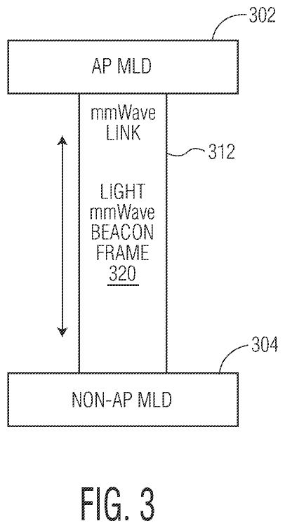

FIG. 3 depicts an mmWave link 312 between an AP MLD 302 and a non-AP MLD 304 that can be used to transmit a light mmWave beacon frame 320. In the embodiment depicted in FIG. 3, the light mmWave beacon frame 320 is transmitted through the mmWave link 312 (e.g., a 45 GHz link or a 60 GHz link) between the AP MLD 302 and the non-AP MLD 304. The light mmWave beacon frame 320 depicted in FIG. 3 is an embodiment of the light mmWave beacon frame 220 depicted in FIG. 2. In one embodiment, at a Target Beacon Transmission Time (TBTT), the light beacon frame is scheduled to be transmitted at least in each beam of the mmWave AP (the AP in an mmWave link) affiliated with the AP MLD 302. The AP MLD 302 depicted in FIG. 3 is an embodiment of the AP MLD 102 depicted in FIG. 1. The non-AP MLD 304 depicted in FIG. 3 is an embodiment of the non-AP MLD 104-1 depicted in FIG. 1. In one embodiment, through the mmWave link, a non-AP MILD can figure out the receiving signal strength or path loss based on the strongest signal among the beams used for transmitting the mmWave beacons by the mmWave AP. Further, the non-AP MLD can figure out whether it can reach the AP MLD through the mmWave link per the received signal strength of the physical layer protocol data unit (PPDU) carrying the mmWave beacon, i.e., executing the frame exchanges with the AP MLD on the mmWave link, and whether it should do the multi-link association with the AP MLD that transmits the mmWave beacon.

In some embodiments, a non-AP MLD that can reach an AP MLD through the mmWave link acquires the full mmWave information, for example, in a non-mmWave link (e.g., a 2.4/5/6 GHz link beacon) of the AP MLD. In a first option, RNR in the non-mmWave beacon is used to announce an mmWave AP affiliated with the same AP MLD as the AP that transmits the beacon or a nontransmitted AP that is in the same multiple BSSID set as the beacon transmitter (the transmitted BSSID AP). In some embodiment, a non-AP MLD can try to receive the beacon of an AP affiliated with an AP MLD in an mmWave link after receiving the beacon of another AP affiliated with the AP MLD in a non-mmWave link. If the non-AP figures out that it can reach the AP MLD through the mmWave link per the strongest signal strength of the mmWave beacons in the beamed PPDUs, the non-AP MLD may use Multi-link (ML) probe request in a non-mmWave link (e.g., a 2.4/5/6 GHz link) to solicit ML Probe Response to acquire the full information of an mmWave link. The other sequence of receiving mmWave Beacon, acquiring the full information of the mmWave link is also possible. In an embodiment, an indication of an AP MLD with an mmWave link is announced in a non-mmWave link (e.g., a 2.4/5/6 GHz link) beacon. After receiving the beacon in a non-mmWave link by a non-AP MLD, the non-AP MLD may use Multi-link (ML) probe request in a non-mmWave link (e.g., a 2.4/5/6 GHz link) to solicit ML Probe Response to acquire the full information of an mmWave link. Based on the full information of an mmWave link, the non-AP MLD can try to receive the beacon in the mmWave link to decide whether it can reach the AP MLD through the mmWave link. In a second option, the non-mmWave link beacon (e.g., the 2.4 GHz, 5 GHz, or 6 GHz link beacon) carries the whole beacon information of an mmWave AP affiliated with an AP MLD. In some embodiments, the whole mmWave beacon information, for example, includes information regarding MAC capabilities that announces the support of the optional MAC features, information regarding PHY capabilities that announces the support of the optional PHY features, the Modulation Coding Scheme (MCS), number of spatial streams (Nss) set that the AP supports, the BSS Basic MCS NSS Set, the BSS operating parameters that are announced in an mmWave light beacon, and/or the broadcast TWT schedule. In a third option, the full beacon in an mmWave link carries the RNR and Multi-Link element for non-mmWave link AP affiliated with the same AP MLD as the mmWave link AP that transmits the Beacon or nontransmitted AP that is in the same multiple BSSID set as the beacon transmitter.

One link's channel switch of an AP MLD can be announced in the beacons of all other links of the AP MLD. The full information of the channel switch of one link may not be able to be announced in the beacon of another link. The channel switch of the other links may be announced by channel switch announcement, extended channel switch announcement, and/or max channel switch time elements. However, the allowed transmission (Tx) power in the new channel and/or the channel puncture can be missing.

In some embodiments, the full information of channel switch of an mmWave link of an AP MLD, i.e., the full information is announced in the beacon (or beacon extension) of 2.4 GHz, 5 GHz, 6 GHz band links of the same AP MLD. The full information may include the channel information with the full BSS operating BW (e.g., the channel switch information element (IE), extended channel switch IE, wide bandwidth channel switch IE being adapted to mmWave information), the transmission (Tx) power information (the channel switch wrapper IE being adapted to mmWave band), the channel puncture information if the Tx power information cannot carry the puncture information, and/or the maximum channel switch time IE.

In some embodiments, when the control/management information of an mmWave link is unicast information (e.g., carried in a unicast frame), the control/management information is transmitted in an mmWave link. Additionally, the information can be carried in a non-mmWave link (e.g., a 2.4/5/6 GHz link) between the MLD pair. For example, the information of power saving (e.g., power management mode, awake/doze state) is transmitted in an mmWave link and other links. In an alternative embodiment, when the control/management information of an mmWave link is unicast information and is not used for link establishment (e.g., association, sounding), the control/management information is transmitted in the mmWave link. In some embodiments, when the control/management information of an mmWave link is broadcast information (e.g., carried in a broadcast frame), the control/management information (e.g., the BSS color change, the channel switch) is transmitted in a non-mmWave link (e.g., a 2.4/5/6 GHz link) supported by the AP MLD. In some embodiments, when the mmWave responding information is required short interframe space (SIFS) after the reception of a soliciting frame, the related frame exchange is done in an mmWave link. One of such frame exchanges may be block acknowledgement request (BAR) and block acknowledgement (BA). In some embodiments, when the frame exchange is for link connection establishment, link maintenance, the frame exchange is done in a non-mmWave link (e.g., a 2.4/5/6 GHz link).

Line-of-sight (LOS) obstruction in an mmWave link may disallow the usage of the mmWave link. The mobility of client or AP device in an mmWave link may destroy the sounding result (e.g., the selected sector and the further refinement). The mmWave link has short distance, i.e., the non-AP MLD may be out of range through the mmWave link. The listening of an mmWave link beacon may consume more power than listening of a non-mmWave link. A non-AP MLD may skip the broadcast frame reception.

In some embodiments, in an mmWave link, a light beacon is transmitted. The light beacon can be used for coexistence between neighbor mmWave APs, e.g., primary channel selection to avoid operating channel overlapping, BSS color collision avoiding etc. In some embodiments, a mmWave STA affiliated with a non-AP MILD uses the mmWave beacon to decide whether it can perform the frame exchanges with the AP MILD whose AP in the mmWave link transmits the beacon. In some embodiments, an mmWave STA does not use the mmWave beacon to acquire the mmWave link operating parameters, an mmWave AP's capabilities. Instead, an mmWave STA acquires the mmWave link operating parameters, the mmWave AP's capabilities through a non-mmWave STA that is affiliated with the same non-AP MLD as the mmWave STA, which means that the AP MILD cannot have all non-mmWave links being disabled/removed. In some embodiments, multi-link (ML) probe request/response cannot be transmitted in an mmWave link, which requires the change of acquiring the channel switch information, multiple Basic Service Set Identifier (BSSID) information acquiring through multi-link association. In some embodiments, the current channel switch information of the reported link cannot be fully acquired. In some embodiments, the current multiple BSSID information of the reported link cannot be fully acquired through association. In some embodiments, a non-AP MLD does not need to monitor the beacons of an mmWave link. A non-AP MLD may need to monitor the beacons of at least one non-mmWave link. One reason for this is that the light deacon may not carry the BSS Parameters Change Count (BPCC) information of the APs affiliated with the same AP MLD as the mmWave AP.

In some embodiments, in an mmWave link, a full beacon is transmitted. In a first option, the full beacon carries RNR, Basic Multi-Link element, and a non-AP MLD can use the mmWave link to acquire the information of the non-mmWave and mmWave APs after the association and acquiring the antenna gain through sounding. In a second option, the full beacon carries RNR, Basic Multi-Link element, and a non-AP MLD can use the mmWave link to acquire the information of the non-mmWave and mmWave APs after the association and acquiring the antenna gain through sounding. However, an AP MLD allows that a non-AP MLD only monitors the non-mmWave link and uses the mmWave link to acquire the full information of the mmWave link (including the updated mmWave link information). This requires the change of acquiring the channel switch information, multiple BSSID information acquiring through multi-link association. In some embodiments, the current channel switch information of the reported link cannot be fully acquired. In some embodiments, the current multiple BSSID information of the reported link cannot be fully acquired through association.

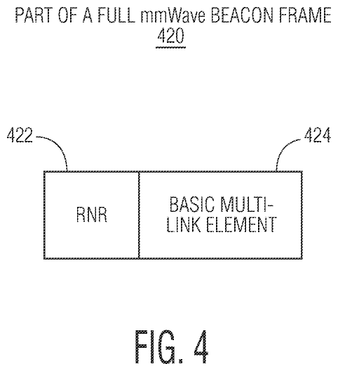

FIG. 4 depicts an example format of part of a full mmWave beacon frame 420 in accordance with an embodiment of the invention. In the embodiment depicted in FIG. 4, the full mmWave beacon frame 420 includes a field 422 containing RNR information and a Basic Multi-Link element 424. Although the fields of part of the full mmWave beacon frame 420 are shown in FIG. 4 as in certain order, other embodiments of the full mmWave beacon frame may include the same, fewer, or more fields in a different order. In addition, since part of the full mmWave beacon frame 420 is shown in FIG. 4 with certain fields, other embodiments of the full mmWave beacon frame may include fewer or more fields to carry the same, less, or more information.

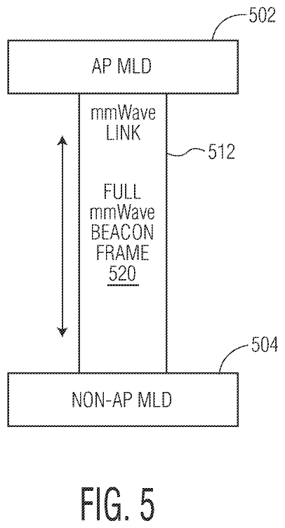

FIG. 5 depicts an mmWave link 512 between an AP MLD 502 and a non-AP MLD 504 that can be used to transmit a full mmWave beacon frame 520. In the embodiment depicted in FIG. 5, the full mmWave beacon frame 520 is transmitted through the mmWave link 512 (e.g., a 45 GHz link or a 60 GHz link) between the AP MLD 502 and the non-AP MLD 504. The full mmWave beacon frame 520 depicted in FIG. 5 is an embodiment of the full mmWave beacon frame whose part information is 420 depicted in FIG. 4. The AP MLD 502 depicted in FIG. 5 is an embodiment of the AP MLD 102 depicted in FIG. 1. The non-AP MLD 504 depicted in FIG. 5 is an embodiment of the non-AP MLD 104-1 depicted in FIG. 1.

Each Traffic Identifier (TID) can be mapped to at least one link. A non-AP MLD can map all the TIDs to a subset of the established links through TID to Link map negotiation. An AP MLD can disable one or multiple links. The TID to link map negotiation can map different links to different TIDs.

Some embodiments of TID to link mapping restriction are described as follows. In some embodiments, each Traffic Identifier (TID) is mapped to at least one non-mmWave link (e.g., a 2.4/5/6 GHz link). In a first option, under TID to link mapping to map all the TIDs to a subset of established links, the TID to link mapping negotiation or the broadcasted TID-to-link mapping in Beacon cannot map all the TIDs to the mmWave links. Under TID to link mapping where different TIDs can be mapped to different links, any TID cannot be mapped to the mmWave links only. In a second option, under TID to link mapping to map all the TIDs to a subset of established links, the TID to link mapping negotiation can map all the TIDs to the mmWave links. Under TID to link mapping where different TIDs can be mapped to different links, any TID can be mapped to the mmWave links only. An AP MLD cannot reject the TID to link mapping request where the TID that is mapped to an mmWave link is requested to be mapped to at least one non-mmWave link because of unreachability through the mmWave link.

Some embodiments of link disabling are described as follows. In some embodiments, an AP MLD cannot disable all its non-mmWave links. In some embodiments, an AP MLD cannot disable a non-mmWave link such that under such link disablement, at least one non-AP MLD has no non-mmWave link being enabled.

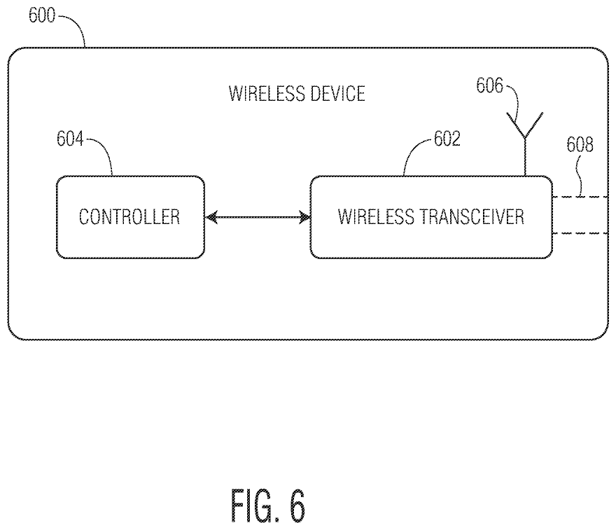

FIG. 6 depicts a wireless device 600 in accordance with an embodiment of the invention. The wireless device 600 can be used in the multi-link communications system 100 depicted in FIG. 1. For example, the wireless device 600 may be an embodiment of the APs 110-1, 110-2, 110-3 and/or the STAs 120-1, 120-2, 120-3 depicted in FIG. 1. However, the APs 110-1, 110-2, 110-3 and the STAs 120-1, 120-2, 120-3 depicted in FIG. 1 are not limited to the embodiment depicted in FIG. 6. In the embodiment depicted in FIG. 6, the wireless device 600 includes a wireless transceiver 602, a controller 604 operably connected to the wireless transceiver, and at least one antenna 606 operably connected to the wireless transceiver. In some embodiments, the wireless device 600 may include at least one optional network port 608 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 600 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 600 may be compatible with an IEEE 802.11 protocol.

In accordance with an embodiment of the invention, the controller 604 is configured to generate a millimeter wave (mmWave) beacon and the wireless transceiver 602 is configured to transmit the mmWave beacon to a second wireless MLD through an mmWave link between a wireless MLD to which the wireless device 600 belongs and the second wireless MLD. In some embodiments, the mmWave beacon includes a light mmWave beacon that does not include full mmWave link information of the mmWave link. In some embodiments, the wireless MLD includes an access point (AP) MLD that includes a wireless AP, and the wireless AP includes the controller and the wireless transceiver. In some embodiments, the second wireless MLD includes a non-AP MLD that includes a non-AP station (STA). In some embodiments, the controller is further configured to generate full mmWave link information of the mmWave link. In some embodiments, the wireless transceiver is further configured to transmit the full mmWave link information of the mmWave link to the second wireless MLD through a non-mmWave link between the wireless MLD and the second wireless MILD. In some embodiments, the non-mmWave link includes one of a 2.4 Gigahertz (GHz) link, a 5 GHz link, or a 6 GHz link. In some embodiments, the wireless transceiver is further configured to transmit the full mmWave link information of the mmWave link to the second wireless MILD through the mmWave link. In some embodiments, the mmWave link includes a 45 GHz link or a 60 GHz link. In some embodiments, the controller is further configured to generate a second mmWave beacon or a beacon extension that contains the full mmWave link information of the mmWave link. In some embodiments, the controller is further configured to generate a multi-link probe response that contains the full mmWave link information of the mmWave link. In some embodiments, the wireless MILD device is compatible with an Institute of Electrical and Electronics Engineers (IEEE) 802.11 protocol. In some embodiments, the controller is further configured to generate a unicast frame that contains control or management information of the mmWave link, and wherein the wireless transceiver is further configured to transmit the unicast frame through the mmWave link. In some embodiments, the controller is further configured to generate a broadcast frame that contains control or management information of the mmWave link, and wherein the wireless transceiver is further configured to transmit the broadcast frame through a non-mmWave link.

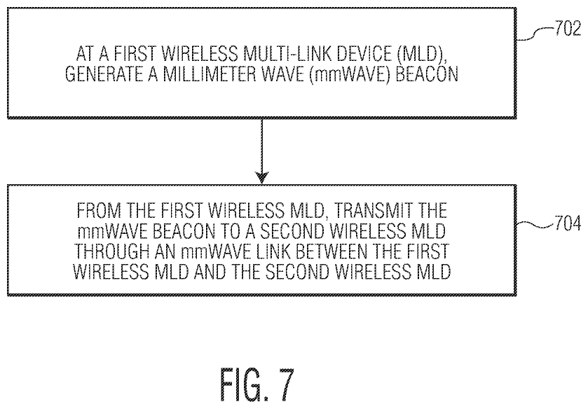

FIG. 7 is a process flow diagram of a method for wireless communications in accordance with an embodiment of the invention. At block 702, at a first wireless multi-link device (MLD), a millimeter wave (mmWave) beacon is generated. At block 704, from the first wireless MLD, the mmWave beacon is transmitted to a second wireless MILD through an mmWave link between the first wireless MLD and the second wireless MLD. In some embodiments, the mmWave beacon includes a light mmWave beacon that does not include full mmWave link information of the mmWave link. In some embodiments, the first wireless MLD includes an access point (AP) MLD, and the second wireless MLD includes a non-AP MILD. In some embodiments, the full mmWave link information of the mmWave link is generated. In some embodiments, the full mmWave link information of the mmWave link is transmitted to the second wireless MLD through a non-mmWave link between the first wireless MLD and the second wireless MLD. In some embodiments, the non-mmWave link includes one of a 2.4 Gigahertz (GHz) link, a 5 GHz link, or a 6 GHz link. In some embodiments, the full mmWave link information of the mmWave link is transmitted to the second wireless MLD through the mmWave link. In some embodiments, the mmWave link includes a 45 GHz link or a 60 GHz link. In some embodiments, a second mmWave beacon or a beacon extension that contains the full mmWave link information of the mmWave link is generated. In some embodiments, a multi-link probe response that contains the full mmWave link information of the mmWave link is generated. In some embodiments, the first wireless MILD is compatible with an Institute of Electrical and Electronics Engineers (IEEE) 802.11 protocol. In some embodiments, a unicast frame that contains control or management information of the mmWave link is generated and transmitted through the mmWave link. In some embodiments, a broadcast frame that contains control or management information of the mmWave link is generated and transmitted through a non-mmWave link. The first wireless MILD may be the same as or similar to the AP MILD 102 depicted in FIG. 1, the AP MILD 302 depicted in FIG. 3, and/or the AP MLD 502 depicted in FIG. 5. The second wireless MLD may be the same as or similar to the non-AP MLD 104-1, 104-2, or 104-3 depicted in FIG. 1, the non-AP MILD 304 depicted in FIG. 3, and/or the non-AP MLD 504 depicted in FIG. 5.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless multi-link device (MLD) comprising:
a controller configured to generate a millimeter wave (mmWave) beacon; and
a wireless transceiver configured to transmit the mmWave beacon to a second wireless MLD through an mmWave link between the wireless MLD and the second wireless MLD.

2. The wireless MILD of claim 1, wherein the mmWave beacon comprises a light mmWave beacon that does not include full mmWave link information of the mmWave link.

3. The wireless MILD of claim 1, wherein the wireless MLD comprises an access point (AP) MLD that comprises a wireless AP, and wherein the wireless AP comprises the controller and the wireless transceiver.

4. The wireless MLD of claim 3, wherein the second wireless MLD comprises a non-AP MLD that comprises a non-AP station (STA).

5. The wireless MILD of claim 1, wherein the controller is further configured to generate full mmWave link information of the mmWave link.

6. The wireless MILD of claim 5, wherein the wireless transceiver is further configured to transmit the full mmWave link information of the mmWave link to the second wireless MILD through a non-mmWave link between the wireless MLD and the second wireless MLD.

7. The wireless MLD of claim 6, wherein the non-mmWave link comprises one of a 2.4 Gigahertz (GHz) link, a 5 GHz link, or a 6 GHz link.

8. The wireless MILD of claim 5, wherein the wireless transceiver is further configured to transmit the full mmWave link information of the mmWave link to the second wireless MILD through the mmWave link.

9. The wireless MILD of claim 8, wherein the mmWave link comprises a 45 GHz link or a 60 GHz link.

10. The wireless MILD of claim 5, wherein the controller is further configured to generate a second mmWave beacon or a beacon extension that contains the full mmWave link information of the mmWave link.

11. The wireless MLD of claim 5, wherein the controller is further configured to generate a multi-link probe response that contains the full mmWave link information of the mmWave link.

12. The wireless MILD of claim 1, wherein the wireless MLD device is compatible with an Institute of Electrical and Electronics Engineers (IEEE) 802.11 protocol.

13. The wireless MILD of claim 1, wherein the controller is further configured to generate a unicast frame that contains control or management information of the mmWave link, and wherein the wireless transceiver is further configured to transmit the unicast frame through the mmWave link.

14. The wireless MILD of claim 1, wherein the controller is further configured to generate a broadcast frame that contains control or management information of the mmWave link, and wherein the wireless transceiver is further configured to transmit the broadcast frame through a non-mmWave link.

15. A wireless access point (AP) of an access point (AP) MILD comprising:
a controller configured to generate a millimeter wave (mmWave) beacon; and
a wireless transceiver configured to transmit the mmWave beacon to a non-AP MILD through an mmWave link between the AP MLD and the non-AP MLD, wherein the mmWave beacon comprises a light mmWave beacon that does not include full mmWave link information of the mmWave link.

16. The wireless AP of claim 15, wherein the controller is further configured to generate full mmWave link information of the mmWave link.

17. The wireless AP of claim 15, wherein the mmWave link comprises a 45 GHz link or a 60 GHz link.

18. A method for wireless communications, the method comprising:
at a first wireless multi-link device (MILD), generating a millimeter wave (mmWave) beacon; and
from the first wireless MLD, transmitting the mmWave beacon to a second wireless MLD through an mmWave link between the first wireless MLD and the second wireless MHLD.

19. The method of claim 18, wherein the mmWave beacon comprises a light 20 mmWave beacon that does not include full mmWave link information of the mmWave link.

20. The method of claim 18, wherein the first wireless MILD comprises an access point (AP) MILD, and wherein the second wireless MLD comprises a non-AP MLD.
